(19) United States
(12) Patent Application Publication
(10) Pub. No.: US 2019/0217346 A1
(43) Pub. Date: Jul. 18, 2019

(54) DUAL-FREQUENCY UNTRASONIC CLEANING APPARATUS

(71) Applicant: Cleanidea Co., Ltd., Incheon (KR)

(72) Inventor: Sung Ho CHO, Goyang-si (KR)

(73) Assignee: Cleanidea Co., Ltd., Incheon (KR)

(21) Appl. No.: 16/247,574

(22) Filed: Jan. 15, 2019

(30) Foreign Application Priority Data
Jan. 15, 2018 (KR) 10-2018-0005240

(51) Int. Cl. B08B 3/12

(52) U.S. Cl. CPC B08B 3/12

(57) ABSTRACT

A dual-frequency ultrasonic cleaning apparatus is disclosed. The dual-frequency ultrasonic cleaning apparatus includes a frequency generator for generating an oscillation frequency of sinusoidal waves, a first transducer for generating a first frequency of ultrasonic waves on the basis of the received oscillation frequency, a second transducer for generating a second frequency of ultrasonic waves on the basis of the received oscillation frequency, an output value measuring unit for measuring output values of the ultrasonic waves generated by the first transducer and the second transducer, and a controller for selecting the oscillation frequency to be generated by the frequency generator within a predetermined bandwidth with respect to a reference band frequency such that the output values of the ultrasonic waves generated by the first transducer and the second transducer become maximum.

### CROSS REFERENCE TO RELATED APPLICATION

The present application claims priority to Korean Patent Application No. 10-2018-0005240, filed Jan. 15, 2018, the entire contents of which is incorporated herein for all purposes by this reference.

### BACKGROUND OF THE DISCLOSURE

### 1. Field of the Disclosure

The present invention relates to an ultrasonic cleaning apparatus and, more particularly, to a dual-frequency ultrasonic cleaning apparatus capable of cleaning an item to be cleaned using two different frequencies without deterioration of cleaning performance.

### 2. Description of the Background Art

Ultrasonic waves are sound waves that are in the form high frequency vibration energy. Specifically, ultrasonic waves refer to sound waves of a frequency above the range of human hearing, which ranges from 16 kHz to 20 kHz.

When such ultrasonic waves are generated in water, micro bubbles are generated due to vibration of sound waves and are then imploded. This is called a cavitation phenomenon.

With repeated creation and collapse of cavitation, that is, when micro bubbles are created and imploded repeatedly, extremely high pressures and temperatures are achieved. When an item to be cleaned is immersed in water where cavitation is occurring, the contaminants attached to the surface of the item to be cleaned are removed due to the high temperature and pressure.

An ultrasonic cleaning apparatus is a device for removing contaminants using this principle.

For efficient cleaning to meet specific cleaning needs, the characteristics that affect the cavitation, for example, the frequency of ultrasonic waves applied to a cleaning fluid, need to be considered.

As the frequency of the ultrasonic waves applied to the cleaning fluid is increased, the linearity and penetration force of the ultrasonic waves are increased. However, the size of the generated bubbles is reduced, resulting the cavitation intensity being weaker. Therefore, for high efficiency cleaning of items that are highly intricate in detail, it is advantageous to use a high frequency of waves.

On the other hand, as the frequency of the ultrasonic waves applied to the cleaning fluid is reduced, the size of the generated bubbles is increased, resulting in the cavitation intensity being stronger. However, in this case, there are problems that the penetrating force is weak and a dead zone in which the ultrasonic waves cannot reach occurs.

A multi-frequency ultrasonic cleaning apparatus, which uses a plurality of frequencies for ultrasonic cleaning, has been used in order to complement the disadvantages of high frequency ultrasonic cleaning apparatuses and the disadvantages of low frequency ultrasonic cleaning apparatuses to maximize the cleaning efficiency. A multi-frequency ultrasonic cleaning apparatus is a type of ultrasonic washing machine that can solve the problems in a case where only one frequency is generated by an oscillator.

However, when a multi-frequency ultrasonic cleaning method has a problem of lowering the cleaning efficiency as compared with a single-frequency ultrasonic cleaning method because the output power achieved by each single frequency is lowered.

For example, assuming that there is a cleaning tank in which 10 oscillators can be placed, a total of 10 oscillators each of which generates a single frequency of 28 kHz may be placed.

On the other hand, when an ultrasonic cleaning apparatus is implemented in a multi-frequency system using 28 kHz and 40 kHz, five oscillators generating a frequency of 28 kHz and five oscillators generating a frequency of 40 kHz may be used. Thus, the number of oscillators generating one specific frequency is reduced.

Accordingly, this case has a problem that the output power per single frequency is reduced as compared with a case where the same number of single frequency oscillators are separately used.

Accordingly, there is the demand for a dual-frequency ultrasonic cleaning apparatus which can solve the problem of the output power drop while using multiple frequencies.

### BACKGROUND OF THE DISCLOSURE

The present invention has been made to solve the above problems, and an object of the present invention is to provide a dual-frequency ultrasonic cleaning apparatus capable of eliminating a problem of output power drop.

The technical problems to be solved by the present invention are not limited to the above-mentioned ones, and other technical problems which are not mentioned about can be understood by those skilled in the art from the following description.

In order to accomplish the object of the present invention, according to an aspect of the present invention, there is provided a dual-frequency ultrasonic cleaning apparatus including: a frequency generator for generating an oscillation frequency of sinusoidal waves; a first transducer for generating a first frequency of ultrasonic waves on the basis of the received oscillation frequency; a second transducer for generating a second frequency of ultrasonic waveforms on the basis of the received oscillation frequency; an output value measuring unit for measuring output values of the ultrasonic waves generated by the first and second transducers; and a controller for determining the oscillation frequency to be generated by the frequency generator from among frequency within a predetermined bandwidth with respect to a reference band frequency such that the output values of the ultrasonic waves generated by the first and second transducers are maximized.

In one embodiment, the controller may select an oscillation frequency at which the output value of the ultrasonic waves generated by the first transducer is maximized and an oscillation frequency at which the output value of the ultrasonic waves generated by the second transducer is maximized.

In one embodiment, the controller may control the frequency generator to vary the oscillation frequency within a predetermined bandwidth with respect to a reference band frequency and determine the oscillation frequencies at which the output values of the ultrasonic waves generated by the first and second transducers are maximized as drive frequencies.

In one embodiment, the controller may control the frequency generator to apply a reference band frequency which is set at an initial stage of driving the ultra-cleaning apparatus as the oscillation frequency and then to vary the oscillation frequency by a predetermined interval within a predetermined bandwidth with respect to the reference band frequency.

In one embodiment, the controller may control the frequency generator to apply a lowest frequency within the predetermined bandwidth with respect to a reference band frequency set at an initial stage of driving the ultrasonic cleaning apparatus as the oscillation frequency and to increase the oscillation frequency by a predetermined interval within the predetermined bandwidth until the increased oscillation frequency reaches a highest frequency within the predetermined bandwidth.

In one embodiment, the controller may re-search for the oscillation frequencies at which the output values of ultrasonic waves generated by the first and second transducers are maximized when a change in environmental factors in a cleaning basin is detected.

With the use of the dual-frequency ultrasonic cleaning apparatus described above, it is possible to apply an oscillation frequency equal to an inherent resonance frequency of a piezoelectric element, which changes according to an environmental factor in a cleaning basin, thereby maximizing the output power of an ultrasonic wave generated by a transducer.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a block diagram illustrating a dual-frequency ultrasonic cleaning apparatus according to one embodiment of the present invention;

FIG. 2 is a flowchart illustrating an exemplary method of controlling the dual-frequency ultrasonic cleaning apparatus according to one embodiment of the present invention;

FIG. 3 is a flowchart illustrating another exemplary method of controlling the dual-frequency ultrasonic cleaning apparatus according to one embodiment of the present invention; and

FIG. 4 is a flowchart illustrating a process of determining timing at which an oscillation frequency search is performed, according to one embodiment of the present invention.

### DETAILED DESCRIPTION OF THE DISCLOSURE

Herein below, preferred embodiments of the present invention will be described in detail with reference to the accompanying drawings. The advantages and features of the present invention and the manner of achieving them will become apparent with reference to the embodiments described in detail below and the accompanying drawings. The present invention may, however, be embodied in many different forms and should not be construed as being limited to the embodiments set forth herein. Rather, these embodiments are provided so that the present invention will be thorough and complete and will fully convey the concept of the invention to those skilled in the art. Thus, the present invention will be defined only by the scope of the appended claims. Like numbers refer to like elements throughout the following description herein.

Unless the context clearly defines otherwise, all terms or words (including technical and scientific terms or words) used herein have the same meanings as common meanings understood by those skilled in the art to which the present invention belongs. Terms defined in a commonly, generally used dictionary are to be interpreted as having the same meanings as meanings used in the related art and should not be interpreted overly ideally unless this application clearly defines otherwise.

As used herein, the singular forms “a”, “an”, and “the” are intended to include the plural forms as well, unless the context clearly indicates otherwise. It will be further understood that the terms “comprises”, “comprising”, “includes”, and “including” when used in this specification specify the presence of stated features, regions, integers, steps, operations, elements and/or components, but do not preclude the presence or addition of one or more other features, regions, integers, steps, operations, elements, components and/or groups thereof.

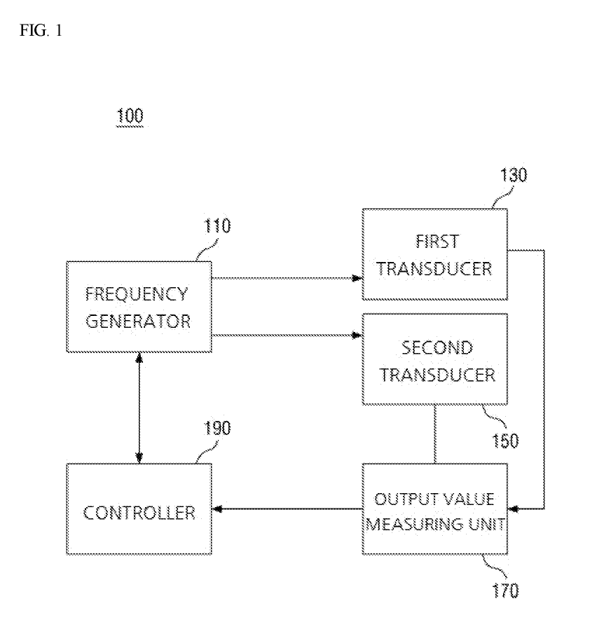

FIG. 1 is a block diagram illustrating a dual-frequency ultrasonic cleaning apparatus 100 according to one embodiment of the present invention.

Referring to FIG. 1, in one embodiment of the present invention, the ultrasonic cleaning apparatus 100 includes a frequency generator 110, a first transducer 130, a second transducer 150, an output value measuring unit 170, and a controller 190.

FIG. 1 illustrates only relevant elements to the embodiment of the present invention, and those skilled in the art will appreciate that other elements are also included in the structure illustrated in FIG. 1.

The frequency generator 110 generates a oscillation frequency of sinusoidal waves for oscillating a transducer. In one embodiment of the present invention, the frequency generator 110 generates an oscillation frequency for oscillating a transducer by adjusting an output frequency within a preset bandwidth. For example, the oscillation frequency is a voltage or current in the form of a sinusoidal wave. In this case, the frequency generator 110 includes a VCO (voltage controlled oscillator) capable of varying the oscillation frequency.

The ultrasonic wave generated by the transducer has a maximum output value when the oscillation frequency of waves applied to the transducer matches an inherent resonance frequency of a piezoelectric element included in the transducer.

Accordingly, in one embodiment of the present invention, the frequency generator 110 is controlled to output an oscillation frequency matching the inherent resonance frequency of the piezoelectric element included in the transducer.

An exemplary method of causing the frequency generator 110 to generate the oscillation frequency matching the resonance frequency of the piezoelectric element included in the transducer will be described in detail below.

The first transducer 130 and the second transducer 150 convert the electric energy input from the frequency generator 110 to generate ultrasonic waves of different frequencies. In this case, oscillation frequencies input to the first transducer 130 and the second transducer 150 differ from each other.

Each of the first transducer 130 and the second transducer 150 includes a piezoelectric element that converts electrical, oscillating, sinusoidal waveforms into mechanical vibrations and generates a predetermined frequency of ultrasonic waves. Since the piezoelectric elements included in the first and second transducers 130 and 150 differ in characteristics, oscillation frequencies for causing the first and second transducers 130 and 150 to maximally vibrate also differ.

On the other hand, the inherent resonance frequencies of the piezoelectric elements are not constant but fluctuate according to environmental factors of a cleaning basin. For example, the inherent resonance frequency of the piezoelectric element changes according to conditions such as the internal temperature of the cleaning basin, the level of a cleaning fluid in the cleaning basin, the amount of a cleaning fluid fed to or discharged the cleaning basin, the quantity or size of an item to be cleaned, and the type of a cleaning agent.

Accordingly, in order for each of the first and second transducer 130 and 150 including the respective piezoelectric elements to output ultrasonic waves with a maximum intensity, sinusoidal waves of the same frequency as the resonant frequency of a corresponding one of the piezoelectric elements need to be applied.

The output value measuring unit 170 measures the output values of the ultrasonic waves generated by the first transducer 130 and the second transducer 150.

The output value measuring unit 170 measures the output value of the ultrasonic wave, which varies according to the frequency of an electrical signal applied by the frequency generator 110. In one embodiment of the present invention, the output value measuring unit 170 calculates the output value of the ultrasonic wave by measuring an output voltage or an output current of each of the transducers 130 and 150.

When the output values of the transducers 130 and 150 are measured in a manner described above, the measured output values are transmitted to the controller 190.

The controller 190 adjusts the oscillation frequency output from the frequency generator 110 within a predetermined bandwidth with respect to a reference band frequency range such that the ultrasonic waves generated by the first transducer 130 and the second transducer 150 have maximum values, respectively.

For example, when the reference band frequency of the ultrasonic waves generated by the first transducer 130 is 28 kHz, the oscillation frequency applied to the first transducer 130 by the frequency generator 110 is determined so as to be within a bandwidth of 28 kHz±3 kHz.

Similarly, when the reference band frequency of the ultrasonic waves generated by the second transducer 150 is 40 kHz, the oscillation frequency applied to the second transducer 150 by the frequency generator 110 is determined so as to be within a bandwidth of 40 kHz±3 kHz.

That is, in one embodiment of the present invention, the controller 190 sets an oscillation frequency at which the output value of the first transducer 130 becomes maximum and an oscillation frequency at which the output value of the second transducer 150 becomes the maximum.

The controller 190 receives the output value of the ultrasonic wave generated by the first transducer 130 when an arbitrary oscillation frequency is applied, and determines the oscillation frequency at which the output value becomes the maximum as the optimum oscillation frequency.

The process of determining the optimum oscillation frequency applied to the second transducer 130 is also performed in the same manner as described above.

The process of determining the optimum oscillation frequencies at which the output values of the respective transducers are maximum is preferably performed when an environmental factor affecting the resonance frequency of each of the piezoelectric elements included in the respective transducers is changed, for example, when the ultrasonic cleaning apparatus starts operating, when mode switching is performed in the ultrasonic cleaning apparatus, or when the amount of a cleaning agent is changed.

With the use of the dual-frequency ultrasonic cleaning apparatus 100 described above, it is possible to apply the oscillation frequency matching the resonance frequency of the piezoelectric element, which fluctuates according to an environmental factor of a cleaning basin, thereby maximizing the output values of the ultrasonic waves generated by the transducers.

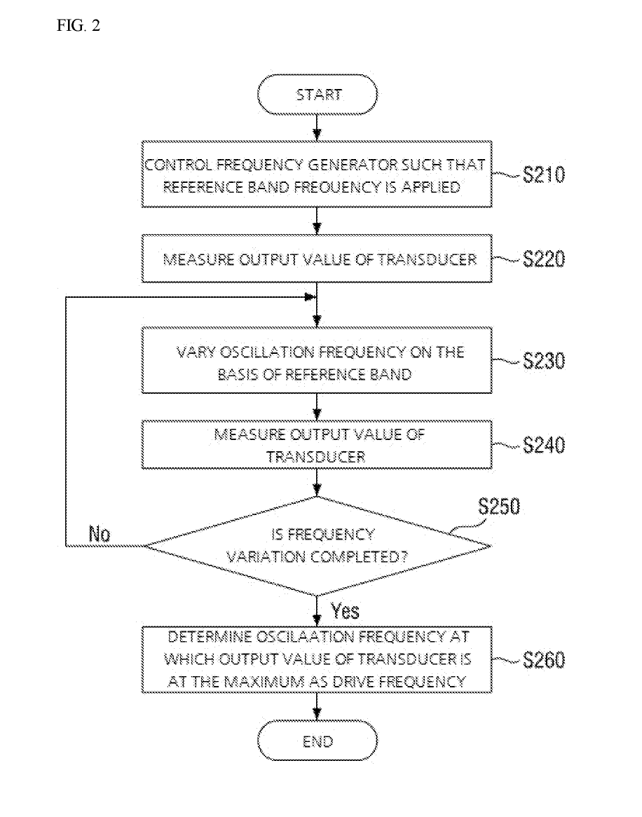

FIG. 2 is a flowchart illustrating an exemplary method of controlling the dual-frequency ultrasonic cleaning apparatus according to one embodiment of the present invention.

The controller 190 controls the frequency generator 110 to apply different reference band frequencies to the first and second transducers 130 and 150, respectively, at step S210. The reference band frequencies are preset according to the characteristics of the piezoelectric elements included in the respective transducers. Specifically, the reference band frequencies are set to match the inherent resonance frequencies of the piezoelectric elements, respectively.

In this embodiment, since the reference band frequency of the first transducer 130 is 20 kHz and the reference band frequency of the second transducer 150 is 48 kHz, 20 kHz and 48 kHz may be applied to the respective transducers as the oscillation frequencies.

When the frequency generator 110 applies the reference band frequencies as the oscillation frequencies to the respective transducers, the output value measuring unit 170 measures the output values of the respective transducers at step S220. As described above, the output value measured by the output value measuring unit is an output voltage or an output current of each transducer.

Thereafter, the controller 190 controls the frequency generator 110 to vary the oscillation frequency applied to the transducer within a predetermined bandwidth with respect to the reference band frequency at step S230. In an exemplary embodiment of the present invention, the controller 190 receives the output values of the ultrasonic waves generated by the transducers while increasing or decreasing the operating frequency by a predetermined interval from the reference band frequency. When the frequency generator 110 applies a changed oscillation frequency, the output value measuring unit 170 measures the output value of the ultrasonic wave generated by a corresponding one of the transducers at step S240.

The above-described procedure is repeatedly performed with each of the frequencies that are increased or decreased by multiples of the predetermined interval from the reference band frequency within the predetermined bandwidth with respect to the reference band frequency. When it is determined that the output value measurement with the frequency being varied within the predetermined bandwidth at step S250, the oscillation frequency at which the output value of the transducer is at the maximum is determined as a drive frequency for the transducer at step S260.

Alternatively, in the embodiment, a frequency other than the reference band frequency may be applied as an initial oscillation frequency applied at the beginning of driving the ultrasonic cleaning apparatus 100.

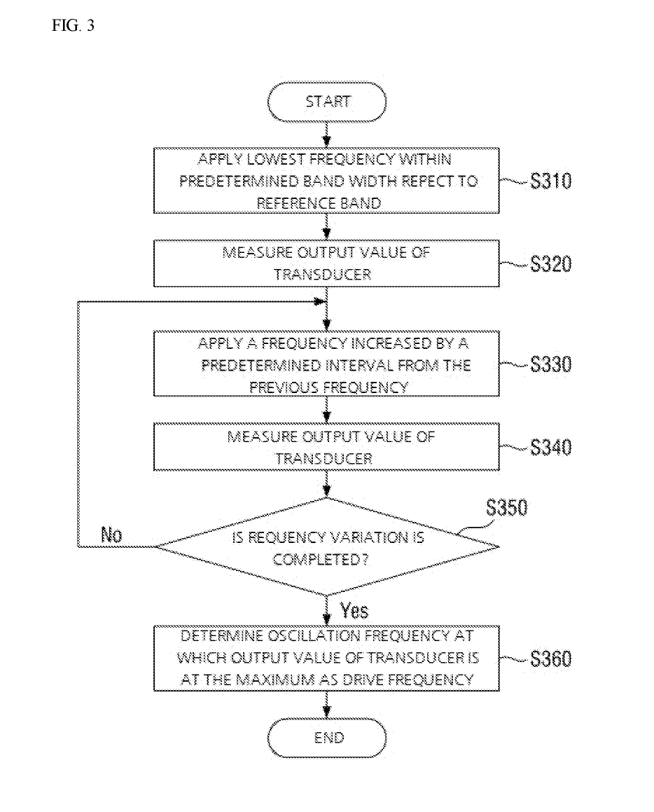

FIG. 3 is a flowchart illustrating another exemplary method of controlling the dual-frequency ultrasonic cleaning apparatus according to one embodiment of the present invention.

The controller 190 controls the ultrasonic generator 110 to apply the lowest frequency within the predetermined bandwidth with respect to a reference band frequency to the respective transducers 130 and 150 as the oscillation frequency at step S310.

In a case where the oscillation frequency is varied within the predetermined bandwidth which is ±1 kHz with respect to a reference band frequency of 28 kHz, the control may be performed such that the lowest frequency of 27 kHz within the predetermined bandwidth is applied as an initial oscillation frequency.

After the lowest frequency within the predetermined bandwidth is applied as the oscillation frequency, the output value of each transducer is measured at step S320. Thereafter, the oscillation frequency is increased by a predetermined internal from the previously used oscillation frequency and then the resulting frequency is applied to each transducer at step S330.

To be more specific, for example, when the predetermined interval is 100 Hz, the lowest frequency of 27 kHz is first applied to the first transducer 130 as the initial oscillation frequency, then the oscillation frequency is increased by 100 Hz from the lowest frequency of 27 kHz, and the resulting frequency which is the sum of 27 kHz and 100 Hz is then applied to the first transducer 130. The process of increasing the oscillation frequency by the predetermined interval and applying the increased frequency is performed until the increased oscillation frequency reaches the highest frequency within the predetermined bandwidth.

Likewise, the lowest frequency of 37 kHz within a predetermined bandwidth respect to a reference band frequency of 48 kHz is first applied to the second transducer 150 as an initial oscillation frequency, then the oscillation frequency applied to the second transducer 150 is increased by a predetermined interval of 100 Hz from the previously used frequency (for example, 47 kHz), and the resulting frequency is then applied to the second transducer 150. The process of increasing the oscillation frequency by 100 Hz and applying the increased frequency is repeatedly performed until the increased oscillation frequency reaches the highest frequency within the predetermined bandwidth.

The output value measuring unit 170 measures the output value of each transducer every time the frequency is changed at step S340. When the frequency oscillation within the predetermined bandwidth is completed, the frequency variation is stopped at step S350. At this time, the frequency variation continues until the highest frequency within the predetermined bandwidth with respect to the reference band frequency is reached.

When the frequency variation is completed, the oscillation frequencies at which the output values of the respective transducers is at the maximum are determined as drive frequencies for the respective transducers at step S360.

Meanwhile, in the embodiment, the lowest frequency within the predetermined bandwidth with respect to the reference band frequency is set as the initial oscillation frequency. However, the control may be performed such that the highest frequency within the predetermined bandwidth with respect to the reference band frequency may be set to as the initial oscillation frequency. In this case, the frequency variation is controlled in such a manner that the frequency is decreased by a predetermined interval from the initial oscillation frequency.

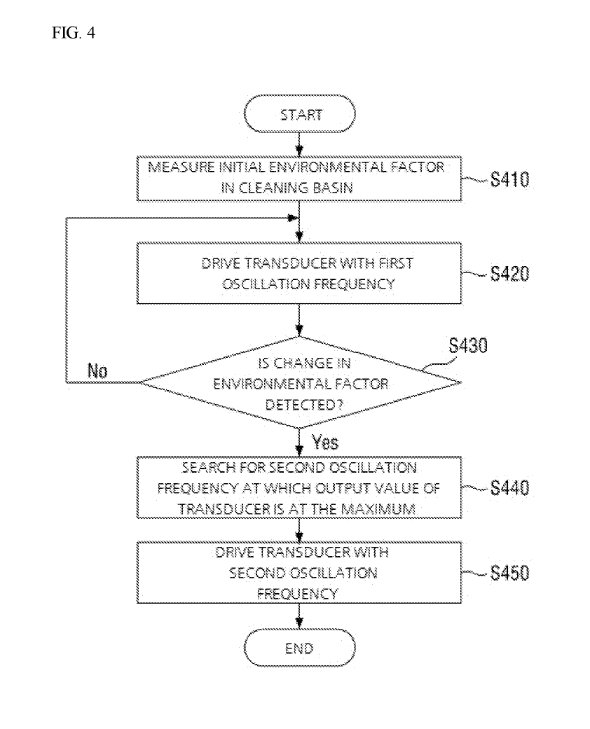

FIG. 4 is a flowchart illustrating a process of determining timing at which an oscillation frequency search is performed, according to the embodiment of the present invention.

The process of searching for the optimum oscillating frequency of each transducer, which is described with reference to FIGS. 2 and 3, is performed at the initial stage of driving the ultrasonic cleaning apparatus 100, but it may be performed when a change in the environmental factor of the cleaning basin is detected.

As described above, when the oscillation frequency output from the frequency generator 110 matches the inherent resonance frequency of the piezoelectric element included in the transducer, the output value of the ultrasonic wave is maximized. This is because the inherent resonance frequency of the piezoelectric element depends on the environmental factor of the cleaning basin.

That is, the process of matching the oscillation frequency output from the frequency generator 110 with the inherent resonance frequency of the piezoelectric element, which changes according to the environmental factor of the cleaning basin, needs to be performed every time the internal environment condition of the cleaning basin changes.

To this end, the controller 190 measures an initial environmental factor of the cleaning basin according to an embodiment of the present invention at step S410. Here, the internal environment conditions of the cleaning basin include temperature, the level of a cleaning fluid, a change in the amount of a cleaning fluid fed to or discharged from a cleaning basin, the amount of an object to be cleaned, and a type of cleaning agent.

To this end, in an embodiment of the present invention, the ultrasonic cleaning apparatus 100 includes a sensor capable of measuring the internal temperature of the cleaning basin, the level of the cleaning fluid, and the change in the amount of the cleaning liquid fed to or discharged from the cleaning basin. Other factors, such as the type of cleaning agent and the type of an object to be cleaned, are input by a user through a user interface provided in the ultrasonic cleaning apparatus 100.

Thereafter, the first transducer is driven by a first oscillation frequency at which the output value of the first transducer becomes maximum at step S420. The method of determining the first oscillation frequency at which the output value of the first transducer becomes the maximum is performed according to the method described in FIG. 2 or FIG. 3.

During the process in which the first transducer is driven by the first oscillation frequency, it is determined whether a change in the environmental factors of the cleaning basin is detected. For example, it is determined whether or not the change in the fluid level in the cleaning basin or the internal temperature exceeds a preset reference value. Alternatively, when the user changes the driving mode of the ultrasonic cleaning apparatus 100 through the user interface, it is determined that there is a change in the environmental factors.

When a change in the environmental factors of the cleaning basin is detected, a second oscillation frequency at which the output value of the second transducer becomes maximum is searched for at step S440. Likewise, a method of searching for the second oscillation frequency is performed according to the method described in FIG. 2 or FIG. 3.

When the second oscillation frequency at which the output value of the second transducer becomes the maximum is found, the second transducer is driven by the second oscillation frequency at step S450.

According to the method of controlling the ultrasonic cleaning 100 described above, it is possible to drive the first and second transducer with the oscillation frequencies optimized for the environmental factors of the cleaning basin, thereby maximizing the cleaning effect by maintaining the ultrasonic output value of the transducer.

Meanwhile, the control method described above is written into a program executable by a computer, the program is recorded on a computer-readable medium, and the control method is implemented in a general-purpose digital computer on the basis of the program recorded on the computer-readable medium. Further, the structure of data used in the control method is recorded on a computer-readable recording medium by various means. The computer-readable recording medium is a storage medium such as a magnetic storage medium (e.g., ROM, floppy disk, hard disk, etc.), and an optical reading medium (e.g., CD-ROM, DVD, etc.).

It will be understood by those skilled in the art that various changes in form and details may be made without departing from the spirit and scope of the invention as defined by the appended claims. Therefore, the disclosed methods should be considered from an illustrative point of view, not from a restrictive point of view. The protection scope of the present invention should be construed as defined in the following claims, and it is apparent that all technical ideas equivalent thereto also fall within the scope of the present invention.

What is claimed is:

1. An ultrasonic cleaning apparatus comprising:
a frequency generator configured to generate an oscillation frequency of sinusoidal waves;
a first transducer configured to generate a first frequency of ultrasonic waves on the basis of the oscillation frequency received from the frequency generator;
a second transducer configured to generate a second frequency of ultrasonic waves on the basis of the oscillation frequency received from the frequency generator;
an output value measuring unit configured to measure an output value of the ultrasonic wave generated by the first transducer and an output value of the ultrasonic wave generated by the second transducer; and
a controller configured to select the oscillation frequency of sinusoidal waves to be output from the frequency generator within a predetermined bandwidth with respect to a reference band frequency such that the output values of the ultrasonic waves generated by the first transducer and the second transducer have respective maximum values.

2. The ultrasonic cleaning apparatus according to claim 1, wherein the controller selects a first oscillation frequency at which the output value of the ultrasonic waves generated by the first transducer is maximized and a second oscillation frequency at which the output value of the ultrasonic waves generated by the second transducer is maximized.

3. The ultrasonic cleaning apparatus according to claim 1, wherein the controller controls the frequency generator to vary the oscillation frequency within the predetermined bandwidth with respect to the reference band frequency and determine oscillation frequencies at which the output values of the ultrasonic waves generated by the first transducer and the second transducers are maximized as drive frequencies for driving the first and second transducers.

4. The ultrasonic cleaning apparatus according to claim 2, wherein the controller controls the frequency generator to apply a reference band frequency generated at an initial stage of driving the ultrasonic cleaning apparatus as the oscillation frequency and to increase or decrease the oscillation frequency by a predetermined interval within the predetermined bandwidth with respect to the reference band frequency.

5. The ultrasonic cleaning apparatus according to claim 2, wherein the controller controls the frequency generator to apply a lowest frequency within the predetermined bandwidth with respect to a reference band frequency set at an initial stage of driving the ultrasonic cleaning apparatus as the oscillation frequency and to increase the oscillation frequency by a predetermined interval until the oscillation frequency reaches a highest frequency within the predetermined bandwidth.

6. The ultrasonic cleaning apparatus according to claim 1, wherein the controller re-searches for oscillation frequencies at which the output values of the ultrasonic waves generated by the first transducer and the second transducer are maximized when a change in an environmental factor in a cleaning basin is detected.
